(19) United States
(12) Patent Application Publication
(10) Pub. No.: US 2009/0216352 A1
(43) Pub. Date: Aug. 27, 2009

(54) METHOD FOR PROVIDING AN IMPROVED MUSIC EXPERIENCE

(75) Inventors: Dag Glebe, Sodra Sandby (SE); Peter Isberg, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/035,687

(22) Filed: Feb. 22, 2008

(51) Int. Cl. G06F 17/00

(52) U.S. Cl. 700/94

(57) ABSTRACT

The present invention provides adapting an audio frequency range to a linear vibrator. This may be achieved by detecting presence of signal components in a first audio frequency range. A control signal may then be provided in response to the detected first signal components. A second signal component in a second frequency range may moreover be obtained and controlled in response to the amplitude of the control signal, wherein the second frequency range is narrower than the first audio frequency range. Feeding of the controlled second signal component to the linear vibrator causing vibrations of the linear vibrator is thus enabled, creating an increased experience of the music when applied to rhythm-based music within a portable communication device such as a mobile phone.

### TECHNICAL FIELD

The present invention relates in general to provision of music and in particular to provision of an improved music experience using a linear vibrator.

### BACKGROUND

The reproduction of low frequency audio signals is not an easy task in small portable communication devices.

It has been suggested to create harmonics of low-frequency signal components, by which it is stated to be possible to suggest presence of such signal components without in reality reproducing them.

From WO 2005/027568 A1 it is known to reproduce low-frequency audio signals by using a dedicated high-Q audio frequency transducer that is fed by an audio frequency generator.

From U.S. Pat. No. 6,134,330, an audio system is disclosed providing means for enhancing an audio signal. These means comprise harmonics generator for generating harmonics of a first part of the audio signal in order to create an illusion that the perceived audio signal includes frequency components lower than those that are present.

There is nevertheless still a need for improving a user's music experience.

### SUMMARY

An object of the present invention is to provide an improved music experience to a user of a portable communication device.

According to some embodiments of the present invention, there is provided a signal processing device for adapting a frequency range to a linear vibrator, the signal processing device comprising a signal detection unit, arranged to detect first signal components in a first audio frequency range and to provide a control signal in response to the detected first signal components, and a signal controlling unit, arranged to obtain a second signal component in a second frequency range, and to control said second signal component in response to the amplitude of the control signal, wherein the second frequency range is narrower than the first audio frequency range, enabling feeding the controlled second signal component to the linear vibrator.

According to some other embodiments of the present invention, there is provided a method for adapting a frequency range to a linear vibrator, the method comprising the steps of detecting first signal components in a first audio frequency range, providing a control signal in response to the detected first signal components, obtaining a second signal component in a second frequency range, and controlling said second signal component in response to the amplitude of the control signal, wherein the second frequency range is narrower than the first audio frequency range, enabling feeding the controlled second signal component to the linear vibrator.

It should be emphasized that the term “comprises/comprising” when being used in the specification is taken to specify the presence of the stated features, integers, steps or components but does not preclude the presence or addition of one or more other features, integers, steps or components or groups thereof.

### BRIEF DESCRIPTION OF THE DRAWINGS

In order to explain the invention and the advantages and features thereof in more detail, embodiments will be described below, wherein references will be made to the accompanying drawings, in which

FIG. 1 is a schematic representation of a signal processing device illustrating some embodiments;

FIG. 2 is a schematic presentation of a portable communication device, illustrating some embodiments; and

FIG. 3 presents method steps in a flowchart illustrating some embodiments.

### DETAILED DESCRIPTION

The underlying idea of at least some embodiments, is adapting frequency components in an audio signal for a linear vibrator, enabling an enhanced music experience.

Especially low frequency components, roughly speaking the frequency components below 500 Hz, may be difficult to reproduce properly by using traditional audio transducers.

Herein, a solution to enhancing the experience of low-frequency frequency components is provided. The solution comprises using a linear vibrator for creating vibrations related to low-frequency content of audio signals.

Frequency components within a first frequency interval of an incoming audio signal can be summarized, and a control signal can be provided based on the amplitude of these frequency components. This control signal can be fed to a controlling unit to control delivering a second frequency signal within a second frequency interval. This controlled second frequency signal may then be fed to a linear vibrator, causing the linear vibrator to vibrate at a frequency corresponding to the second frequency component of the signal that is fed to the linear vibrator.

By adapting signal components from the first frequency interval to a second frequency component that typically has one frequency component, the frequency components from the first interval may be represented by a signal frequency within the second frequency range. It should be noted that the second frequency range may be comprised in the first frequency range.

However, this potential frequency shift, which may exist for frequency components within the first frequency range, which are substantially separated in frequency from the second frequency component, are most likely acceptable to the experience of the music presented by the input signal.

Since the frequency range of interest in particular is a low-frequency range, say below 500 Hz, the music content of the signal is a low frequency tone.

In rhythmic music such as pop-music, rock-music, funk, reggae, punk, hip-hop and the like, the actual frequency of low frequency content is seldom critical for the music experience. For this reason, in the case a frequency shift is introduced by providing the second frequency component instead of an initial first frequency component, a person experiencing the music will most likely not even notice the frequency shift per se, and even more likely not consider to the shift to be harmful to the music. This is because of that the low frequency components in rhythm-base music provide at least part of the rhythm, in contrast to other genres of music in which the actual tone of a low frequency signal component may be of considerable importance.

With reference to FIG. 1 some embodiments of a signal processing device I 00 will now be described.

According to some embodiments the signal processing device comprises a audio frequency filter 102, a signal detecting unit 104, and a signal control unit. The audio frequency filter unit may comprise an audio frequency pass-band filter. According to some embodiments the audio frequency filter is a low-pass filter.

The audio frequency filter 102 may thus be arranged to filter an audio frequency signal such that audio frequencies within a pass-band are passed through the filter, without severely affecting the amplitude of frequency components within this pass-band.

In the case of a low-pass audio frequency filter signal components having low frequencies may be passed through the audio frequency filter 102 substantially unaffected in terms of amplitude.

From the audio frequency filter 102 a first signal components may thus be obtained by the signal detecting unit 104. As mentioned above, this detection unit 104 may integrate the frequency signal components according to some embodiments.

The frequency components may be frequency integrated by the signal detection unit 104, providing a frequency independent and time dependent control signal that represents the envelop of the low frequency content of the first signal.

According to alternative embodiments the signal detection unit 104 may process the first signal components differently, without using explicit integration of the signal components, still taking the amplitude of at least some of the frequency components into account.

The detection unit 104 may then provide a control signal to the controlling unit 106. As indicated in FIG. 1, showing a schematic representation of a signal processing device illustrating some embodiments, the controlling unit of the signal processing device may be connected to a signal generator 108. This signal generator 108, which may not be comprised in the signal processing device I 00, is arranged to generate the second signal component.

The frequency of this second signal component is typically chosen such that the linear vibrator 110, to which a signal below will be fed, has a maximum or close to maximum sensitivity. Linear vibrators are typically tuned to have a high Q-value, which means that they response to a narrow frequency range. Linear vibrators are known from the state of the art, and are for this reason not further discussed here.

The controlling unit 106 is thus arranged to control the second signal component in response to the amplitude of the control signal, as received from the signal detection unit 104.

The controlling unit 106 may forward the second signal component in dependence of the amplitude of the control signal. In the case the control signal has zero intensity or amplitude the controlling unit will typically not forward the second signal component.

The controlling unit controls the second signal component continuously. In the case the time dependent control signal as provided by the signal detection unit, shows an intensity or a time dependent amplitude the controlling unit forwards the second signal component with an amplification in dependence of the intensity of the control signal.

For example, in the case a time dependent envelop is comprised in the control signal, and this control signal is provided to the controlling unit, the controlling unit controls the second signal component as provided from the signal generator 108, by amplifying the second signal component such as the amplitude of the controlled second signal component is based on the amplitude or intensity of the control signal. Alternatively, the controlling unit 106 may provide the second signal component with an amplitude in dependence of the amplitude of the control signal, as provided from the signal detection unit 104.

The controlled second signal component may then be fed to the linear vibrator causing the linear vibrator to vibrate according to the frequency of the second signal component. It is obvious that internal oscillations relative to a vibrator casing of the linear vibrator, causes the entire linear vibrator to vibrate.

The linear vibrator may moreover also vibrate based on the amplitude of the controlled second signal component. The higher amplitude of the controlled second signal component, the higher amplitude of the oscillations of the linear vibrator.

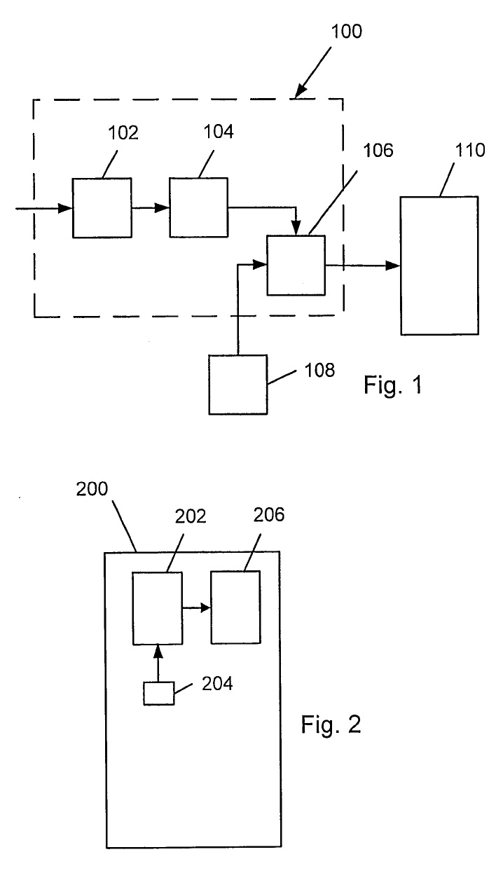

FIG. 2, shows a schematic presentation of a portable communication device 200 according to some embodiments.

The portable communication device in FIG. 2 is presented as a mobile phone, and may comprise a signal processing device 202, a signal generator 204 and a linear vibrator 206.

The signal processing device 202 may thus obtain a second signal component from the signal generator 204, such that the signal processing device 202, and more precisely the controlling unit 106 of the signal processing device 202, can control the second signal component. The signal processing device 202 may thus feed a controlled second signal component to the linear vibrator causing the linear vibrator to oscillate in dependence of the amplitude of the control signal.

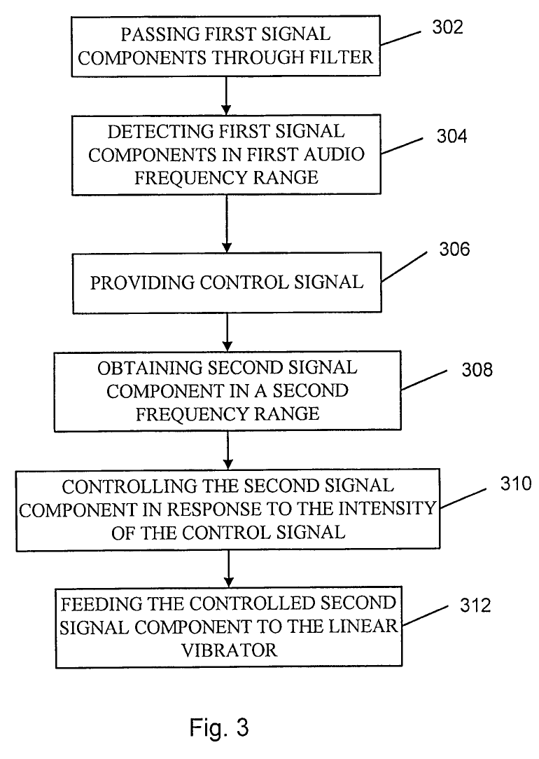

With reference to FIG. 3, presenting method steps in a flowchart illustrating some embodiments, a method for providing an improved music experience according to some embodiments will now be described.

The method may start with the step of passing first signal components through a filter in step 302. This step may be performed by the filtering unit 102, which thus may pass first signal components within a pass band of frequencies to a signal detection unit 104.

The signal detection unit 104 may perform detecting first signal components in first audio frequency range, step 304, where the first signal components typically are those that where comprised in the pass band of the filtering unit 102 of the signal processing device 100.

The detected first signal components in the first low frequency range, may be comprised in the frequency range of 30 Hz-150 Hz.

According to another embodiment the first low frequency range comprises the frequency range of 50 Hz-120 Hz.

Having detected the first signal components in the step of providing a control signal component is then executed in step 306. This step may also be performed by the signal detection unit 104 of the signal processing device 100. This control signal may be created by integrating the first signal components in the first signal frequency range, creating a time-dependent control signal.

It can be noted that the control signal is typically not frequency dependent as the integration may preferably be performed in the frequency dimension. The resultant is thus a control signal that is time dependent and that reflects the amplitudes of each component of the first signal frequency range.

The following step according to the method for improving the user experience of music, is the step of obtaining second signal component in a second frequency range. This step may be performed by the controlling unit 106 of the signal processing device 100. The second signal component may be provided by a signal generator 204, which may be comprised in a portable communication device 200, according to at least some embodiments. This signal generator is arranged to generate a signal having a frequency that is well suited for the linear vibrator in the way that the linear vibrator shows a pronounced oscillation sensitivity for this frequency or frequency range.

Thereafter the step of controlling the second signal component in response to the intensity of the control signal, step 310, can be performed. This step may be performed by the controlling unit 106.

As was described above in connection to the signal processing device 100 as schematically presented in FIG. 1, controlling the second signal component controls the amplitude of the second signal such that various strengths of oscillations of the linear vibrator may be provided. In addition the step of controlling controls when to activate the linear vibrator, forwarding pulses or intensity peaks in the controlled second component such that the linear vibrator can oscillate based on the instantaneous intensity of the controlled signal.

When serving a rhythm-based audio signal to the filtering unit 102, the controlled second signal component, preferably comprises peaks separated by practically zero signal intensity in between, representing the music beat, causing the linear vibrator to oscillate according during the beats of peaks, such that a user of a portable communication device, comprising the signal processing device, the signal generator and the linear vibrator, can experience an improved music experience. The music experience comprises experiencing vibrations caused by the linear vibrator.

As a beneficial side effect the linear vibrator may in addition form an audible tone having the same frequency as the frequency of the signal generator 204. This is indeed a side effect as the linear vibrator may not be constructed so as to produce audible tones.

For completeness, it can be added that the final step of the method as presented herein may be the step of feeding the controlled second signal component to the linear vibrator, step 312, as already discussed above.

According to some embodiments, some units as presented separately may be realized in a single unitary unit, according to alternative embodiments.

It is emphasized that the present embodiments can be varied in many ways, of which the alternative embodiments as presented are just a few examples. These different embodiments are hence non-limiting examples. The scope of the present invention, however, is only limited by the subsequently following claims.

It is thus easy to understand that the embodiments comes with some advantages of which one is that low frequency signals that may be difficult to reproduce in small portable communication devices, can be represented by activations of a linear vibrator.

1. A signal processing device for adapting a frequency range to a linear vibrator, the signal processing device comprising:
a signal detection unit, arranged to detect first signal components in a first audio frequency range and to provide a control signal in response to the detected first signal components, and
a signal controlling unit, arranged to obtain a second signal component in a second frequency range, and to control said second signal component in response to the amplitude of the control signal,
wherein the second frequency range is narrower than the first audio frequency range, enabling feeding the controlled second signal component to the linear vibrator.

2. The signal processing device according to claim 1, wherein the signal controlling unit further is arranged to obtain the control signal from the signal detection unit.

3. The signal processing device according to claim 1, wherein the signal detection unit comprises a signal integrator adapted to integrate the first signal components in the first audio frequency range, to provide the control signal.

4. The signal processing device according to claim 1, further comprising audio frequency filter arranged to pass first signal components in a first audio frequency range.

5. The signal processing device according to claim 1, wherein the signal controlling unit is arranged to detect signals in the second frequency range that is comprised in the first frequency range.

6. The signal processing device according to claim 1, where the signal controlling unit is arranged to control a second signal component for which the linear vibrator has substantially maximum sensitivity in the second frequency range.

7. A method for adapting a frequency range to a linear vibrator, the method comprising the steps of:
detecting first signal components in a first audio frequency range,
providing a control signal in response to the detected first signal components,
obtaining a second signal component in a second frequency range, and
controlling said second signal component in response to the amplitude of the control signal,
wherein the second frequency range is narrower than the first audio frequency range, enabling feeding the controlled second signal component to the linear vibrator.

8. The method for adapting a frequency range to a linear vibrator according to claim 7, wherein the method further comprises obtaining the control signal for the step of controlling.

9. The method for adapting a frequency range to a linear vibrator according to claim 7, wherein the step detecting comprises frequency integrating the first signal components in the first audio frequency range, for providing the control signal.

10. The method for adapting a frequency range to a linear vibrator according to claim 7, the method further comprising passing first signal components in a first audio frequency range.

11. The method for adapting a frequency range to a linear vibrator according to claim 7, wherein the second frequency range is comprised in the first frequency range.

12. The method for adapting a frequency range to a linear vibrator according to claim 7, wherein the step of controlling further comprises controlling a second signal component for which the linear vibrator has substantially maximum sensitivity in the second frequency range.

13. A portable communication device comprising a signal processing device according to claim 1.

14. The portable communication device according to claim 13, further comprising a signal generator arranged to generate the second signal component, and a linear vibrator, arranged to obtain the controlled second signal component, for providing an improved music experience.

15. The portable communication device according to claim 13, wherein the device comprises a mobile phone.
